(19) United States
(12) Patent Application Publication
(10) Pub. No.: US 2017/0259964 A1
(43) Pub. Date: Sep. 14, 2017

(54) WINCH HANDLE BOTTLE CAPS AND METHODS FOR MAKING AND USING

(71) Applicant: Yang Suh, Honolulu, HI (US)

(72) Inventor: Yang Suh, Honolulu, HI (US)

(21) Appl. No.: 15/439,959

(22) Filed: Feb. 23, 2017

Related U.S. Application Data
(60) Provisional application No. 62/304,947, filed on Mar. 8, 2016.

(51) Int. Cl. B65D 41/04; B21D 51/44; B65D 41/12; B21D 22/02; B67B 3/02; B67B 7/18

(52) U.S. Cl. CPC B65D 41/0485; B67B 3/02; B67B 7/18; B65D 41/12; B21D 22/02; B21D 51/44

(57) ABSTRACT

A novel closure for bottles comprising a bottle cap having a socket that is shaped and sized to receive the drive head of a convention winch handle. The closure is particularly useful for bottled beverages brought aboard sailboats that use manually winches. The closures can be removed from the bottles using winch handles that are already aboard the sailboat, allowing the beverages to be consumed. Methods for making and using the novel closures for bottles are also described.

### CROSS-REFERENCE TO RELATED APPLICATIONS

This U.S. Non-Provisional Utility Patent Application claims the benefit, under 35 U.S.C. §119, of U.S. Provisional Patent Application No. Ser. No. 62/304,947 filed Mar. 8, 2016 by the present inventor, the contents of which are incorporated herein in their entirety.

### STATEMENT REGARDING FEDERALLY SPONSORED RESEARCH OR DEVELOPMENT

No government funding was used in the conception, development or reduction to practice of this invention.

### FIELD OF THE INVENTION

The invention relates to closures for bottles. More specifically, this invention describes bottle caps that are opened by a conventional winch handle and methods for making and using said bottle caps.

### BACKGROUND OF THE INVENTION

A winch or capstan is a mechanical device used to pull in (tighten) or let out (loosen) or otherwise adjust the “tension” of a rope or wire. In its simplest form it consists of a spool and attached hand crank. Winches can be found in machines as diverse as tow trucks, steam shovels and elevators. More elaborate designs have gear assemblies and can be powered by electric, hydraulic, pneumatic or internal combustion drives. Some may include a solenoid brake and/or a mechanical brake or ratchet and pawl device that prevents it from unwinding unless the pawl is retracted.

Winches are most common, and almost universally found on sailing vessels apart from small sailboats. Sailboat winches are used to tension the lines of the sailboat that include halyards, the lines used to hoist and lower the sails, and sheets, the lines used to tighten or trim the sails while underway. As such, winches are essential to the proper operation of most sailboats.

Apart from very large sailboats where the winches may be mechanically powered, the winches on small and medium sized sailboats are operated manually through the use of a winch handle or crank. Winch cranks consist of an arm, a rotating grasp or handle that extends perpendicular from one end of the crank arm, and a drive head or lug that extends perpendicular (parallel to the handle) from the opposing side of the crank arm.

When in use, the drive head of the winch crank is inserted into the axially aligned socket formed within the winch drum. The winch crank is then rotated manually to rotate the winch drum which, which wrapped with rope, pulls and tightens the rope.

While winch cranks come in a wide variety of shapes, sizes and construction material, they all share drive heads having a standard size and shape in order to be received into winch drum sockets that all exhibit the same size and shape. By convention, winch crank drive heads demonstrate eight triangular splines that extend out laterally to exhibit an octagonal star shaped cross-section. The outside diameter of the drive head is approximately ⅞ inch whereas the diameter between splines is approximately ¾ inch. Conventional winches have a drum socket that is also octagonal star shaped in cross section with the same inside and outside dimension so that the winch crank drive fits snugly there within.

Depicted in FIG. 1 is a conventional winch handle or crank. Extending from the left bottom of winch handle is the drive head portion or lug 12 of the winch handle demonstrating the conventional octagonal star shape.

Beverages are frequently consumed aboard sailboats and those beverages are often bottled beverages having closures that comprise metal bottle caps. Most metal bottle caps need to be pried off with a bottle opener in order to access the bottle contents. Not uncommonly, the necessary bottle opener is forgotten, cannot be found, or is inconveniently stored somewhere within the boat cabin when needed above board. The winch handle or crank, on the other hand, is almost always to be found at the sailboat crew's finger tips as the handle is essential for trimming the sails and tightening other lines required for the proper operation of the sailboat.

A primary object of the present invention is to provide for a bottle cap that can be used for bottles brought aboard sailing vessels that can be opened using tools already likely to be present aboard the vessel.

A further object of the present invention is to provide for a bottle closure that can be easily and conveniently opened using a conventional winch handle.

Other objects and advantages of the present invention will become apparent from the description and illustration of the invention as found herein.

### SUMMARY OF THE INVENTION

These and other objects are accomplished through the subject invention, novel bottle caps or closures designed to receive the drive head of a standard sized winch handle, and methods for making and using said bottle caps or closures.

The bottle caps of the subject invention comprise a socket that exhibits an octagonal star shape, shaped and sized to receive the drive head of a conventional winch handle or crank. In other respects, the bottle caps of the subject invention function similarly to commercially available bottle caps, and as such can be crimped or screwed onto the lip of the bottle.

One aspect of the present invention is to provide a closure for bottles that can be removed using the drive head of a conventional winch handle.

Another aspect of the present invention is to provide for a bottle cap that receives a standard sized winch handle.

Another aspect of the present invention is to provide a closure for bottles that can be removed using a conventional winch handle, easily, without damage to the bottle.

A further aspect of the present invention is to provide for a bottle cap that can receive and be rotated or levered using a winch crank of the type commonly found on sailing vessels.

Still yet another aspect of the present invention is to provide for a closure for bottles that can be opened by a conventional winch handle through the forces of rotating and/or prying or both.

### BRIEF DESCRIPTION OF THE DRAWINGS

FIG. 1 illustrates in exploded view a conventional winch handle in relation to a novel bottle cap of the subject invention in relation to the bottle being capped and/or uncapped.

FIG. 2 depicts different views of one preferred embodiment of the novel bottle cap of the subject invention.

### DETAILED DESCRIPTION OF PREFERRED EMBODIMENTS

The instant invention is a means for closing bottles containing beverages, said closure means comprising a closure body, a socket formed in the top of said body accessible from above, and a closure means on the bottom of said body for closing and sealing the top of the bottle.

The socket formed in the top of the closure body is sized and shaped to received the lug of a conventional, standard sized, winch handle. The socket may be sufficiently deep to receive the entire length of the of the winch handle lug, or it may be shallower, to receive a partial length only of the distal portion of the winch handle lug.

The closure means on the bottom of said body for closing the top of the bottle may be a flange that extends out from the bottom of the body and that is affixed to the top of the bottle by crimping the flange around the lips of a bottle, as in the case of prior art pry-off bottle caps. Alternatively, the closure means on the bottom of said body for closing the top of the bottle may comprise a threaded flange that extends down from the bottom of the body and that is affixed to the top of the bottle by screwing down over threads present around the lip of the bottle bottom, as in the case of prior art screw-off bottle caps.

The novel closure means of the subject invention may be fabricated of metal, or plastic, or other materials, including composite materials, and may be fabricated from more than one material or composite material. The closure means can be fabricated in accordance with conventional methods including, by way of example, molding, stamping or extruding.

Bottles closed using the novel closure means of the subject invention are glass bottles, but can also include bottles made of other materials including, without limitation, plastic bottles. Such bottles will typically contain beverages of all sorts and variety but the novel closure means of the instant invention is expected to find greatest use in the case of bottled alcoholic beverages and, in particular, bottled beer.

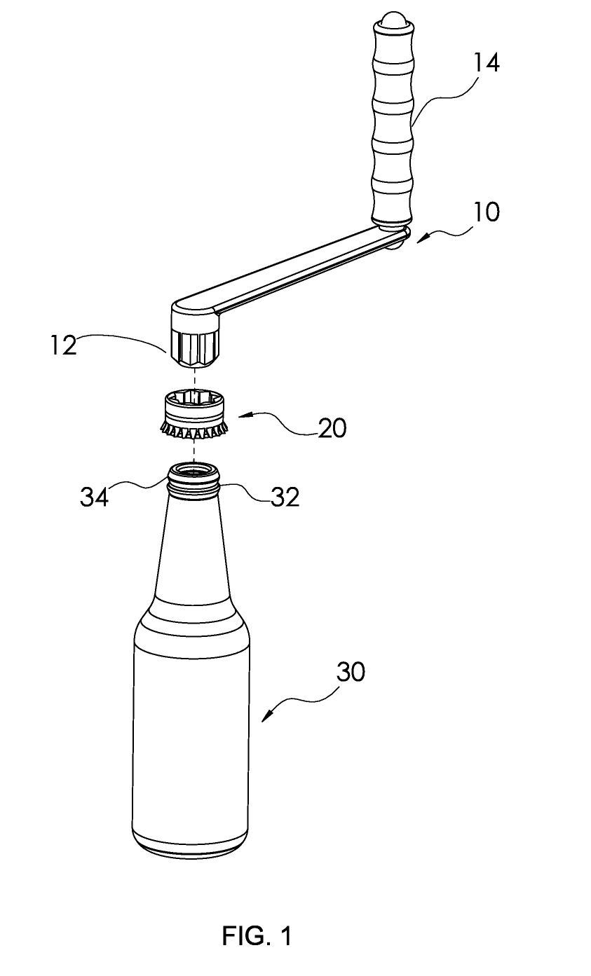

Depicted in FIG. 1 in exploded view is a conventional winch handle 10 in relation to one preferred embodiment of the novel closure means 20 of the subject invention in relation to a bottle 30 to be closed. Extending downward from the bottom of the winch handle is a conventional, standard shaped and sized winch handle lug 12. Lug 12 demonstrates the conventional eight triangular-shaped splines that extend laterally out from the center of lug 12. When winch handle 10 is rotated, winch handle lug 12 also rotates.

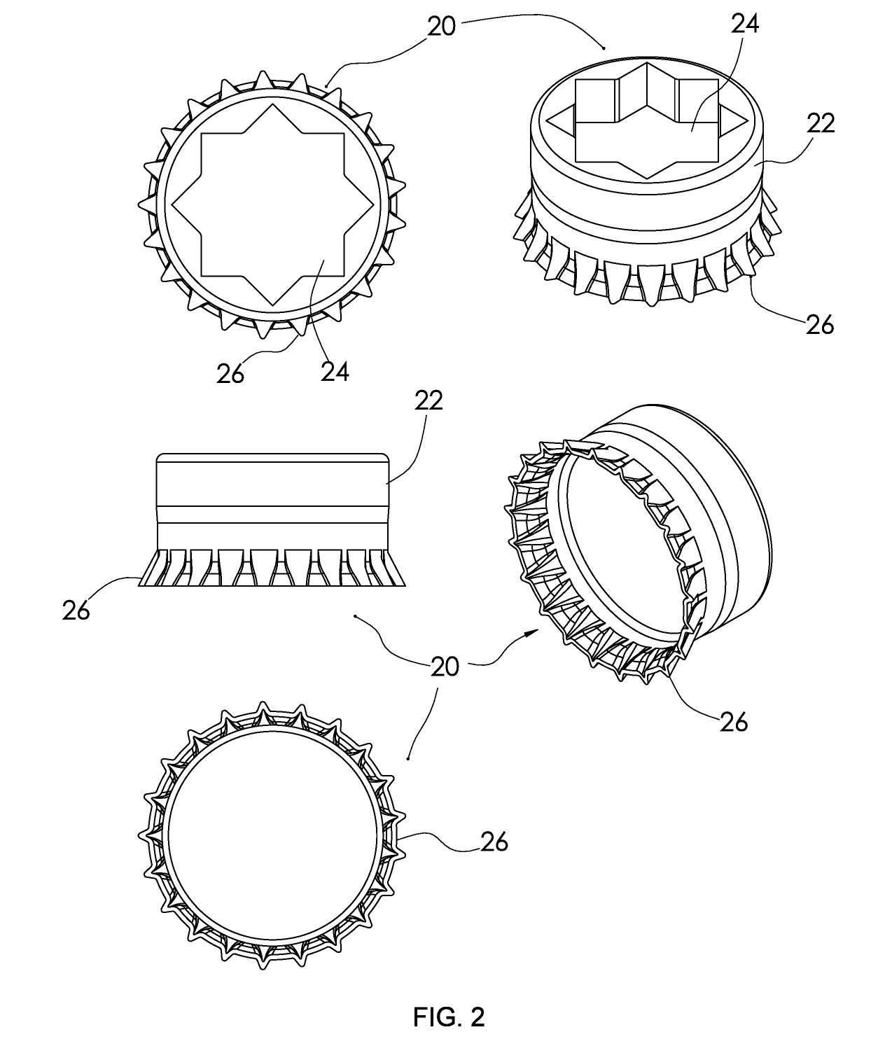

The novel bottle closure 20 means illustrated in FIGS. 1 and 2 comprises a body 22, a socket 24 formed in the top of said body, and an flange 26 extending out and down from the bottom of said body exhibiting crimps. The bottle 30 illustrated in FIG. 1 has a horizontal lip 32 that receives a pry-off style bottle cap.

One embodiment of the novel closure means of the instant invention is illustrated in several view in FIG. 2. The preferred embodiment closure means exhibits a body 22 that is round and approximately the outside diameter of the neck 34 of the bottle that it caps. Formed in the top of the body is a socket 24 shaped and sized to receive the lug 12 or winch drive of a conventional winch handle 10. As such, the inside circumferences of socket 24 is formed by eight triangular shapes.

Along the bottom of the body of the preferred embodiment closure 20 illustrated in FIGS. 1 and 2 is a flange 26 that extends outward and downward and is shown formed with crimps. As illustrated, the bottom flange is un-crimped. In order to close bottle 30, bottom flange 26 is crimped over top lip 34 of bottle 30 such as the one illustrated in FIG. 1.

The manner of using the novel closure means of the instant invention can best be understood by references again to FIG. 1. The bottle cap closure means 20 (illustrated also in FIG. 2) is closed over top lip 34 of bottle 30 by crimping bottle flange 26 of closure means 20 over the top lip of bottle 30. This seals bottle 30 and prevents fluid from entering or escaping in the same way as a prior art pry-off bottle and bottle cap.

To remove novel closure means 20 from bottle 30, lug 12 of conventional winch handle 10 is inserted into socket 24 formed in the top of bottle cap closure means 20 of the instant invention. Lug 12 demonstrates the conventional eight triangular-shaped splines to fit into socket 24 that exhibits a mirror image of the eight triangular-shaped splines of winch handle lug 12 such that socket 24 receives lug 12 precisely and snugly. Next, the handle portion 14 of winch handle 10 is grasped and handle 14 is rotated either clock-wise or counterclockwise, applying a torque force on closure means 20, removing bottle cap closure means 20 from bottle 30 rendering the contents of bottle 30 available for consumption.

Although rotation of winch handle 10 is one method for removing closure means 20 from bottle 30, winch handle 10 can, alternatively, be levered upwards, thereby applying a lateral force to closure means 20, prying closure means 20 off bottle 30. Still another method for removal of preferred embodiment closure means 20 illustrated in FIGS. 1 and 2 is to both rotate and lever winch handle 10, at the same time, applying simultaneously both a torque force and a lateral force to closure means 20, thereby facilitating the removal of bottle cap 20 from bottle 30.

Although bottle 30 illustrated in FIG. 1 has a pry-off type bottle top with single lip 32, the preferred embodiment closure means of the subject invention can also be used with a screw-type bottle that exhibits angled threads along its top portion. In the case of a screw top bottle, the method of opening would be mainly by way of rotating the winch handle and not levering the winch handle. Also, while prior art screw top bottles can sometimes be opened without the need for bottle openers or other tools, the novel closure means of the present invention will facilitate the easier opening of screw top bottles and the novel closure means can be affixed to screw top style bottles more firmly and securely than is the case with conventional screw top bottle caps so that they are not easily opened by hand, and require a tool such as a which handle to open.

Many commercially available winch handles are manufactured with locking plates extending from beneath the winch lug to prevent the winch handle from being pulled from the winch socket accidentally. The novel closure means 20 of the subject invention is easily modified to accommodate locking winch handles by modifying socket 24 of closure means 20 to accommodate the locking plate together with lug 12.

### SUMMARY AND SCOPE

As explained and illustrated above, the novel bottle cap closure means of the subject invention are caps that can receive the lug of a standard sized winch handle such that manipulation of the winch handle removes the cap from the bottle.

The terms “a,” “an,” “the,” and similar references used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventor intends for the invention to be practiced otherwise than specifically described herein.

For example although not illustrated here but contemplated to be within the scope and spirit of the present invention are alternative embodiment closure means that receive a convention winch handle and by which the closure means are removed from bottles by rotating and/or levering the winch handle. Such alternative embodiments include, but are not limited to, closure means wherein the rotation of the winch handle lug within the closure means socket serves to pull upwards and outwards the crimped bottle flange of the closure means to loosen and/or release the bottom flange from said bottle.

Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A closure for bottles comprising a body, a socket formed in the top of said body sized and shaped to receive a conventional winch handle lug, and a closure means extending from the bottom of said body for closing and sealing the top of said bottle.

2. A closure for bottles comprising a bottle cap with socket formed in the top thereof, said socket shaped and sized to receive the drive head of a conventional winch handle.

3. A closure for bottles comprising a bottle cap with socket formed in the top thereof, said socket shaped and sized to receive a lug that demonstrates eight triangular-shaped splines extending laterally.

4. The closure of claim 3, wherein the outside diameter of the lug is approximately ⅞ inch and the inside diameter of the lug is approximately ¾ inch.

5. The closure of claim 3, wherein the socket has a depth equal to the length of said lug.

6. The closure of claim 3, wherein the socket has a depth that is less than the length of said lug.

7. A method for making a closure for bottles with lips, comprising the steps of:
a. stamping a piece of material with flanges extending from the bottom thereof;
b. forming a socket in the middle of said piece of material, said socket having a shape and size to receive the drive head of a conventional winch handle; and
c. affixing said piece to the top of a bottle by closing said flanges of the over the lip of the bottle.

8. The method of claim 7, wherein said bottle lip is continuous and horizontal and the flanges are closed over said bottle lip by crimping.

9. The method of claim 7, wherein said bottle lip and the flange of the closure are both threaded and the piece is affixed to the top of said bottle by screwing the flanges of said piece over the lip threads of said bottle.

10. The method of claim 7, wherein the outside diameter of the socket is approximately ⅞ inch and the inside diameter of the socket is approximately ¾ inch.

11. A method for opening bottles, comprising the steps of:
a. providing a bottle;
b. providing a bottle closure means with socket formed in the top thereof, said socket shaped and sized to receive the drive head of a conventional winch handle;
b. providing a winch handle with conventional drive head;
c. inserting the drive head of said winch handle into said closure means socket; and
d. rotating and/or levering the winch handle to pry said bottle closure means off said bottle.

12. The method of claim 11 wherein the bottle is a screw top bottle with threads and the winch handle is rotated to screw said bottle closure means off of said bottle top.
